(19) United States
(12) Patent Application Publication
(10) Pub. No.: US 2021/0235935 A1
(43) Pub. Date: Aug. 5, 2021

(54) APPLIANCE FOR PREPARING AND/OR COOKING FOOD, SUCH AS A FOOD PROCESSOR WITH INTEGRATED WEIGHING DEVICE

(71) Applicant: BEABA, Paris (FR)

(72) Inventor: Laurent NOCA, Hauterives (FR)

(73) Assignee: BEABA, Paris (FR)

(21) Appl. No.: 16/972,752

(22) PCT Filed: May 29, 2019
(86) PCT No.: PCT/FR2019/051277

§ 371 Date: Dec. 7, 2020

(30) Foreign Application Priority Data
Jun. 5, 2018 (FR) 18/70649

(51) Int. Cl. A47J 43/07; A47J 43/046; A47J 36/32; A47J 36/34; G01G 19/56

(52) U.S. Cl. CPC A47J 43/0716; A47J 43/046; A47J 43/0727; A47J 2043/0733; A47J 36/34; G01G 19/56; A47J 36/32

(57) ABSTRACT

An appliance for preparing and/or cooking food, such as a food processor, including at least: a bowl including at least one internal cooking and/or preparation volume, a base on which the bowl is arranged in its operating state, the base including at least one bottom and at least one sidewall extending from the bottom in an intersecting direction, the bottom and the sidewall defining an internal volume, a weighing device configured to weigh at least the contents of the bowl and includes at least two weighing sensors, wherein the weighing device is arranged in the internal volume of the base, and the appliance includes a support plate that's separate from the base and is arranged facing the bottom of the base, the sensors comprising at least one first portion positioned on the bottom of the base and at least one second portion positioned on a part of the support plate.

### DESCRIPTION

The present invention concerns the field of small household appliances intended for heating food containers and/or for cooking foodstuffs and/or for preparation of foodstuffs. Preferably, but without limitation, the invention applies to the field of small household appliances for childcare.

There are many small household appliances dedicated in particular for the preparation of foodstuffs and the cooking thereof or not within the same bowl associated with a non-integrated weighing device such that the foodstuffs or the content of the bowl is weighed outside the appliance, which is somehow impractical and sometimes less accurate when making complex recipes. Many preparation and/or cooking appliances integrating a weighing device connected to a controller equipped with a display arranged on the base of the appliance or on another portion of the appliance visible to a user have been developed. The interest of the integration of this scale lies in the execution speed and the simplicity of the weighing and also in the fact that it is easy to implement in the appliance commands relating to recipes including foodstuffs weighing.

Some integrated weighing devices may be in the form of a tray or a movable drawer coming out of the base of the appliances, on which the preparation bowl is positioned or the foodstuffs to be weighed are placed directly. The main drawback of this arrangement relates to the displacement of the content to be weighed from the weighing tray into the bowl ready to use or else the displacement of the bowl itself, which does not really change with regards to a weighing with a non-integrated scale apart that the weight is displayed on the appliance and may be taken into account in the automatic execution of recipes.

Other weighing devices are integrated into the feet of the appliance, which has the advantage of being compact and fully integrated into the appliance. However, the feet support the weight of the entire appliance, which is complex for the calibration of the weighing device and which reduces the weighing accuracy of the bowl and its contents only.

The invention aims at remedying all or part of the aforementioned drawbacks by proposing a foodstuffs preparation and/or cooking appliance integrating a weighing device therewithin while preserving a targeted weighing accuracy on the bowl and its content.

To this end, the invention relates to an appliance for preparing and/or cooking foodstuffs, such as a kitchen food processor, comprising at least:

one foodstuffs preparation and/or cooking bowl including at least one cooking and/or preparation inner volume,

one base on which the bowl is disposed in the operating state of the appliance, the base comprising at least one bottom and at least one sidewall extending from the bottom support in a substantially secant direction, the bottom and the at least one sidewall delimiting an inner volume,

one weighing device configured to weigh at least the content of the appliance bowl comprising at least two weighing sensors,

characterized in that the weighing device is arranged in the inner volume of the base, and in that the appliance comprises a support plate distinct from the base and arranged opposite the bottom of the base, each of the weighing sensors comprising at least one first portion positioned on the bottom of the base and at least one second portion positioned on a portion of the support plate.

Thanks to this arrangement, it is possible to integrate the weighing function into the appliance in a simple way and to enable weighing of the content of the bowl only because the weighing device is located inside the base of the appliance and not outside. Furthermore, the position of the at least one sensor between the bottom of the base and the support plate is advantageous because it enables a translational deforming movement according to an axis Z-Z, especially as the bottom is shaped so as to bear the weight of all of the components of the appliance except for the support plate.

Preferably, the weighing device comprises several weighing sensors, even more preferably three or four weighing sensors, preferably identical, which allow increasing the weighing accuracy.

According to a feature of the invention, each weighing sensor is arranged astride between the bottom of the base and the support plate.

Advantageously, the weighing device is positioned on the bottom of the base in one or several dedicated housing(s) and provided on the bottom of the base, which allows isolating the weighing sensors from the rest of the components of the base so as to have an accurate measurement of the weight of the bowl and its content with as less disruptive elements as possible.

According to a feature of the invention, at least one of the weighing sensors is a strain gauge sensor. Preferably, all weighing sensors consist of strain gauge sensors.

According to a feature of the invention, each sensor comprises a flange covering the strain gauge.

According to a feature of the invention, the weighing device comprises four weighing sensors whose strain gauges are connected in a Wheatstone bridge.

According to a feature of the invention, the weighing sensors are connected to each other by a wired connection.

According to a feature of the invention, the weighing sensors extend in a plane substantially parallel to the plane in which the bottom of the base extends.

According to a feature of the invention, the bottom of the base extends in a plane substantially parallel to the plane in which the support plate extends.

In order to fasten each strain gauge, each of the strain gauges cooperates with a stud provided on the support plate and rests partially on the sidewall.

Advantageously, the weighing sensors are arranged at a distance from one another and preferably at the corners of the base.

According to a feature of the invention, the number of weighing sensors is determined by the geometry of the base. For example, when the base is quadrangular, the weighing device preferably comprises four weighing sensors each arranged preferably at each corner of the base.

According to a feature of the invention, the bowl comprises a lower portion shaped so as to cooperate with a stand arranged on the base of the appliance.

According to a feature of the invention, the base may have a polygonal shape for example rectangular or cylindrical or frustoconical.

According to a feature of the invention, the bottom of the base is substantially parallel to the bowl stand.

According to a feature of the invention, the at least one sidewall comprises a peripheral edge forming a fillet at the periphery of the bottom of the base.

According to a feature of the invention, the inner volume of the base is closed partially by the bowl stand and partially by an upper face. Advantageously, the bowl stand and the upper face may consist of two distinct parts or an integral part.

Advantageously, the upper face extends in a plane substantially inclined with respect to the plane in which the bowl stand extends, which improves the ergonomics of the appliance.

Advantageously, the bottom has a geometry shaped so as to insulate the wiring of the different components of the appliance so that the latter do not hinder the operation of said components. In other words, the bottom of the base allows confining the wiring in the lower part of the base.

According to a feature of the invention, the bottom of the base is arranged beneath the bowl stand and the upper face of the base.

Advantageously, the bottom of the base may be formed integral with the at least one sidewall of the base or else distinctly from the at least one sidewall of the base.

According to a feature of the invention, the appliance comprises at least one foot and preferably several feet, arranged on the support plate independently of the position of the weighing sensors.

According to a feature of the invention, the support plate comprises a first face opposite the bottom of the base and a second face, opposite to the first face, on which the at least one foot and preferably the feet of the appliance is/are positioned.

According to a feature of the invention, the appliance comprises a controller.

According to a feature of the invention, the controller is housed on the base, preferably in the column beneath the tub and the heating member.

According to a feature of the invention, the controller comprises several components, including at least one circuit board and one memory.

According to a feature of the invention, the controller is configured to control the activation of the appliance by an actuator in the form of a pushbutton.

According to a feature of the invention, the controller is configured to drive the weighing device.

According to a feature of the invention, the controller drives the drive motor of the appliance.

According to a feature of the invention, the controller is configured to control the heating member.

According to a feature of the invention, the controller comprises a display member configured to display temperature information measured by a temperature sensor and/or speed information acquired by the controller and/or weight information of the content of the bowl, measured by the at least one weighing sensor of the weighing device and/or the progress of previously stored recipe programs, etc.

According to a feature of the invention, the controller comprises at least one and preferably a plurality of control elements in the form of buttons which enable the selection of monitoring modes or points such as the tub temperature, the cooking time, the rotational speed of the cutting member (not represented), the cutting/mixing or blending time, etc.

According to a feature of the invention, the temperature information is measured by a temperature sensor (not represented) present in the bowl or in the tub for example, said temperature sensor communicating with the controller and being monitored by the controller so that when the tub or the bowl reaches a selected temperature or a threshold temperature, the temperature sensor sends the temperature information to the controller, which displays it and which depending on the action to be carried out, either switches off the heating member or prolongs the operating time of the heating member, for example.

According to a feature of the invention, the information on the rotational speed of the cutting member is collected by the controller depending on the rotational speed of the drive shaft driving the cutting and/or blending member and driven by the motor and the transmission.

According to a feature of the invention, the weight information measured by the weighing device is collected by the controller and may be displayed on the display member of the controller.

According to a feature of the invention, the recipe programs are stored in the memory of the controller. Advantageously, each program comprises a sequence of actions to be carried out, which may be for example, the activation or switching off of the drive motor at a determined speed for blending or for cutting the content of the bowl; the activation or switching off of the heating member of the appliance to cook or heat the content of the bowl; the activation of the weighing device; the pouring of a preparation into the bowl or the removal of a preparation from the bowl, etc.

According to a feature of the invention, the sequence of actions to be carried out may be performed automatically and/or manually depending on the type of action to be carried out: for example, a foodstuff is manually poured into the bowl and cutting of said foodstuff is manually launched, the speed is automatically adjusted depending on the foodstuff and the motor stops automatically according to a determined time.

According to a feature of the invention, the appliance comprises a column including a heating member and a tub. Advantageously, the tub is intended to be heated by the heating member and configured to receive water to be boiled using the heating member.

According to a feature of the invention, the tub is preferably in fluid communication with the bowl.

According to a feature of the invention, the heating member is driven by the controller, that is to say, the controller orders the activation or switching off of the heating member.

According to a feature of the invention, the column is hermetically closed by a plug.

According to a feature of the invention, the column is positioned on the base next to the bowl.

According to a feature of the invention, the appliance according to the invention further comprises a lid configured to at least partially seal the bowl.

According to a feature of the invention, the appliance comprises a drive motor connected by a transmission and a drive shaft to a cutting and/or blending member disposed in the bowl.

The invention will be better understood, thanks to the description hereinafter, which relates to an embodiment according to the present invention, provided as non-limiting example and explained with reference to the appended schematic figures. The appended schematic figures are listed below:

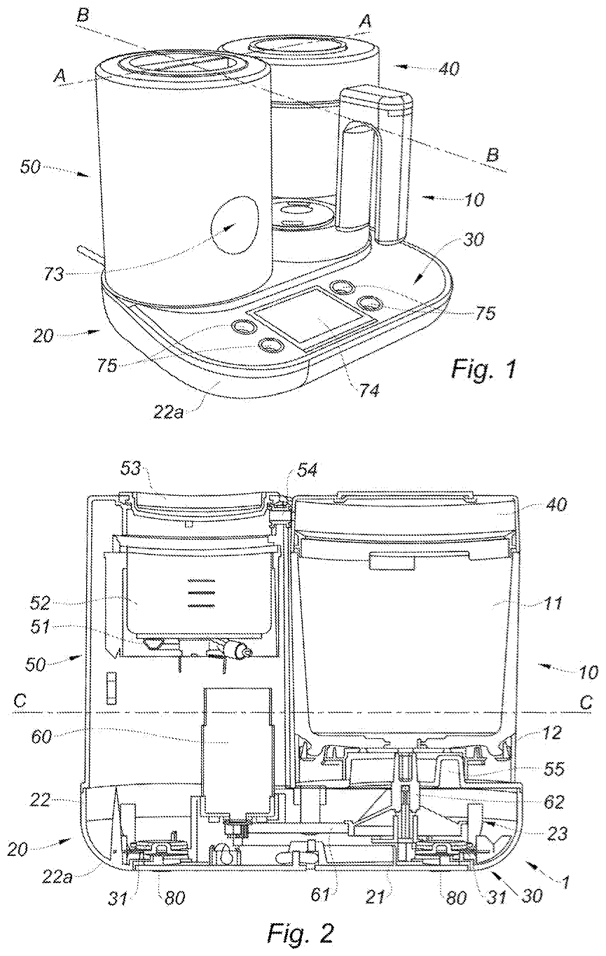

FIG. 1 is a perspective view of the appliance according to the invention,

FIG. 2 is a longitudinal sectional view, according to a cutting axis A-A illustrated in FIG. 1, of the appliance according to the invention,

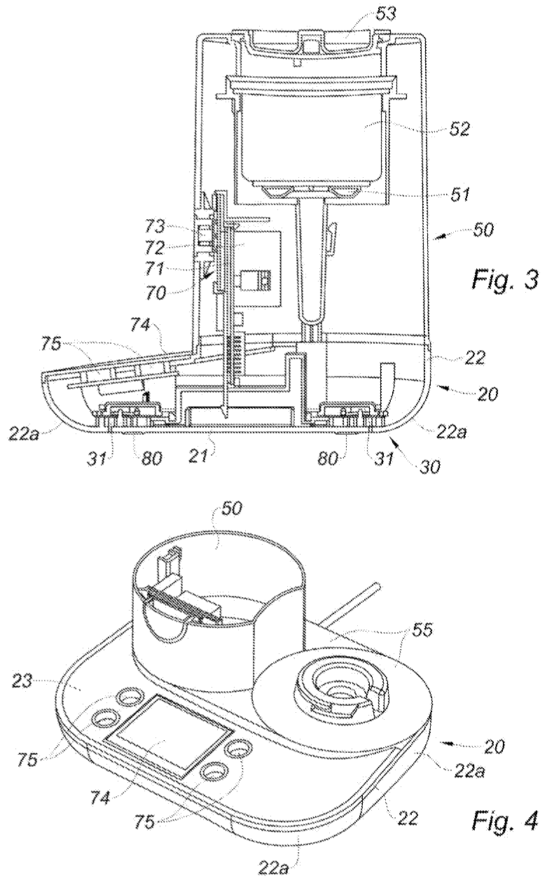

FIG. 3 is a sectional view, according to a cutting axis B-B illustrated in FIG. 1, of the appliance according to the invention,

FIG. 4 is a partial perspective view of the appliance according to the invention,

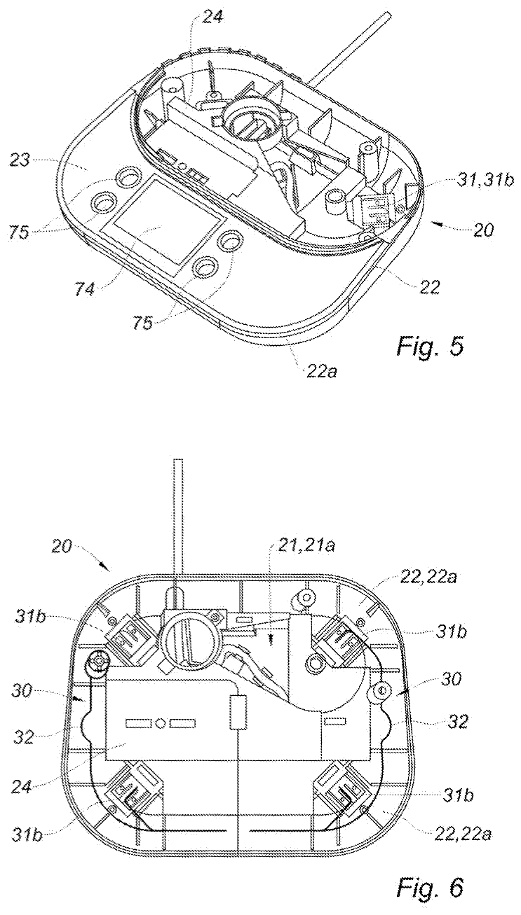

FIG. 5 is a partial perspective view of the appliance according to the invention,

FIG. 6 is a sectional top view of the base of the appliance according to the invention,

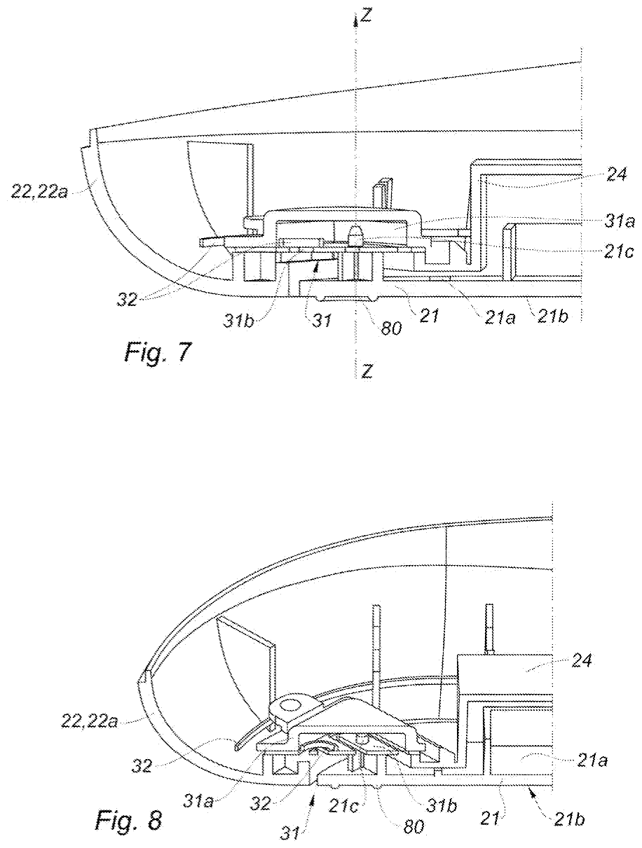

FIG. 7 is a partial sectional view of a detail of the base of the appliance according to the invention,

FIG. 8 is a perspective view of FIG. 7.

The appliance 1 according to the invention is a foodstuffs preparation and/or cooking appliance such as a kitchen food processor. As illustrated in FIG. 1, the appliance 1 comprises a foodstuffs preparation and/or cooking bowl 10, a base 20 on which the bowl 10 is disposed in the operating state of the appliance 1, a weighing device 30 configured to weigh at least the content of the bowl 10 of the appliance 1. The appliance 1 according to the invention further comprises a lid 40 configured to at least partially seal the bowl 10, a column 50 including a heating member 51 and a tub 52. The appliance 1 according to the invention further comprises a controller 70 illustrated for example in FIG. 3. The appliance 1 according to the invention comprises a drive motor 60 connected by a transmission 61 and a drive shaft 62 to a cutting and/or blending member (not represented) disposed in the bowl 10 as illustrated in FIG. 2.

As illustrated in FIG. 2, the bowl 10 includes an inner volume 11 of bowl 10. The bowl 10 may comprise a cooking basket (not represented) fitted to the inner volume 11. The bowl 10 is closed with the lid 40. The bowl comprises a lower portion 12 shaped so as to cooperate with a bowl stand 55 arranged on the base 20 of the appliance 1, as shown in FIG. 4.

As illustrated in particular in FIGS. 2, 3, 7 and 8, the base 20 comprises a bottom 24 and at least one sidewall 22 extending from the bottom 21 in a substantially secant direction, the bottom 24 and the at least one sidewall 22 delimiting an inner volume. In the example illustrated in FIGS. 1 to 6, the base 20 has a rectangular shape; nevertheless, the latter may have another shape without departing from the scope of the invention. For example, the base 20 may have a polygonal or cylindrical or frustoconical shape.

According to the invention, the bottom 24 of the base 20 is substantially parallel to the appliance 1 stand 55. In addition, the at least one sidewall 22 comprises a peripheral edge 22a forming a fillet at the periphery of the bottom 24 of the base 20 as shown in FIGS. 1 to 8.

In accordance with the invention, the inner volume of the base 20 is closed partially by the bowl stand 55 and partially by an upper face 23 as illustrated in FIG. 4 for example. The bowl stand 55 and the upper face 23 may consist of two distinct parts or an integral part. Advantageously, the upper face 23 extends in a plane substantially inclined with respect to the plane in which the bowl stand 55 extends, which improves the ergonomics of the appliance 1.

As represented in FIG. 5 in particular, the bottom 24 is preferably arranged beneath the bowl stand 55 and the upper face 23. The bottom 24 may be formed integral with the at least one sidewall 22 of the base 20 or else distinctly from the at least one sidewall 22 of the base 20. In the example illustrated in the figures, the separator support 24 is distinct from the sidewall 22.

According to the invention, the appliance further comprises a support plate 21 arranged opposite the bottom 24 of the base 20. The support plate 21 comprises a first face 21a placed opposite the bottom 24 of the base 20 and a second face 21b opposite to the first face 21a. The appliance 1 comprises a plurality of feet 80 arranged on the second face 21b of the support plate 21 irrespective of the position of the weighing sensors 31, as illustrated in FIGS. 2, 3, 7 and 8.

In accordance with the invention, the weighing device 30 is configured to weigh at least the content of the bowl 10 of the appliance 1. The weighing device 30 comprises at least one weighing sensor 31 and preferably four identical weighing sensors 31 as illustrated in particular in FIG. 6. The weighing device 30 is positioned in the inner volume of the base 20, on the bottom 24 of the base 20.

In the example illustrated according to the invention, the weighing sensors 31 consist of strain gauge sensors. Each sensor 31 comprises a flange 31a covering the strain gauge 31b. Each strain gauge 31b is connected in a Wheatstone bridge. The sensors 31 are connected to each other by a wired connection 32.

As shown in particular in FIG. 6, the sensors 31 extend in a plane substantially parallel to the plane in which the bottom 24 of the base 20 extends. More particularly, each sensor 31 comprises at least one first portion positioned on the bottom 24 of the base 20 and at least one second portion positioned on a portion of the support plate 21 as illustrated in details in FIGS. 7 and 8. Each strain gauge 31b cooperates with a stud 21c of the support plate 21 and rests partially on the bottom 24 or the lateral portion 22 of the base 20, and more particularly on the edge 22a of the sidewall 22. As shown in FIG. 6, the sensors 31 are advantageously arranged at a distance from one another and preferably at the corners of the base 20. Of course, the number of weighing sensors 31 is determined by the overall geometry of the base. For example, when the base is quadrangular, the weighing device preferably comprises four weighing sensors each arranged preferably at each corner of the base.

In accordance with the invention and as illustrated in particular in FIG. 3, the controller 70 is housed in the column 50 beneath the tub 52 and the heating member 51. Of course, this arrangement is not restrictive and the controller could surely be arranged in another portion of the appliance 1 for example in the base 20 yet without departing from the scope of the invention. The controller 70 comprises several components including at least one circuit board 71 and a memory 72 as illustrated in FIG. 3.

In accordance with the invention, the controller 70 is configured to control the operation of the appliance 1 by an actuator 73 in the form of a pushbutton, in the example illustrated in FIGS. 1 and 3. Furthermore, the controller also controls the drive motor 60.

According to the invention, the controller 70 comprises a display member 74 configured to display temperature information and/or speed information and/or weight information of the content of the bowl and/or the progress of previously stored recipe programs, etc. Moreover, the controller 70 comprises at least one and preferably a plurality of control elements 75 in the form of buttons which enable the selection of control modes or points such as the tub temperature, the cooking time, the rotational speed of the cutting member (not represented), the cutting/mixing or blending time, etc.

In accordance with the invention, the temperature information is measured by a temperature sensor (not represented) present in the bowl 10 or in the tub 52 for example, said temperature sensor communicating with the controller 70 and being monitored by the controller 70 so that when the tub or the bowl reaches a selected temperature or a threshold temperature, the temperature sensor sends the temperature information to the controller 70 which displays it and which depending on the action to be carried out, either switch off the heating member or prolongs the operating time of the heating member, for example.

In accordance with the invention, the information on the rotational speed of the cutting member is collected by the controller 70 depending on the rotational speed of the drive shaft 62 driving the cutting and/or blending member and driven by the motor 60 and the transmission 61.

In accordance with the invention, the weigh information is measured by the weighing device 30, collected by the controller 70 and can be displayed on the display member 74.

In accordance with the invention, the recipe programs are stored in the memory 72 of the controller 70, each program comprises a sequence of actions to be carried out which may for example consist of, activating or switching off the drive motor 60 at a determined speed for blending or cutting the content of the bowl 10; the activation or switching off of the heating member 51 of the appliance 1 to cook the content of the bowl 10; the activation of the weighing device 30; the pouring of a preparation into the bowl 10 or the removal of a preparation from the bowl 10, etc. The sequence of actions to be carried out may be performed automatically and/or manually depending on the type of action to be carried out: for example, a foodstuff is manually poured into the bowl and the cutting of said foodstuff is manually initiated, the speed is automatically adjusted depending on the foodstuff and the motor is automatically switched off according to a determined time.

In accordance with the invention, the column 50 is hermetically closed by a plug 53. The column 50 is positioned on the base 20 next to bowl 10. The column 50 may be made integral with the stand 55 of bowl 10 or distinctly. Advantageously, the tub 52 is intended to be heated by the heating member 51 and configured to receive water to be boiled by means of the heating member 51. The tub 52 is preferably in fluid communication with the bowl 10 as shown in FIG. 2, the steam passing through a conduit 54 connecting the column 50 to the bowl 10. Advantageously, the heating member 51 is driven by the controller 70, that is to say, the controller orders the activation or switching off of the heating member 51, and it may control, in an optimized version of the appliance 1, the heating power of the heating member 51.

Indeed, the invention is not limited to the embodiment described and represented in the appended figures. Modifications remain possible, in particular with regards to the constitution of the various elements or by substitution with technical equivalents, yet without departing from the scope of the invention.

1. An appliance for preparing and/or cooking foodstuffs, such as a kitchen food processor, comprising at least:
one foodstuffs preparation and/or cooking bowl including at least one cooking and/or preparation inner volume,
one base on which the bowl is disposed in the operating state of the appliance, the base comprising at least one bottom and at least one sidewall extending from the bottom in a substantially secant direction, the bottom and the at least one sidewall delimiting an inner volume,
one weighing device configured to weigh at least the content of the bowl of the appliance comprising at least two weighing sensors,
wherein the weighing device is arranged in the inner volume of the base, and in that the appliance comprises a support plate distinct from the base and arranged opposite the bottom of the base, each of the weighing sensors comprising at least one first portion positioned on the bottom of the base and at least one second portion positioned on a portion of the support plate.

2. The appliance, according to claim 1, wherein the weighing device is positioned on the bottom of the base in one or several dedicated housings and arranged on the bottom of the base.

3. The appliance according to claim 1, wherein at least one of the weighing sensors is a strain gauge sensor.

4. The appliance according to claim 3, wherein the weighing device comprises four weighing sensors whose strain gauges are connected in a Wheatstone bridge.

5. The appliance according to claim 1, wherein the bottom may be formed integral with the at least one sidewall of the base or else distinct from the at least one sidewall of the base.

6. The appliance according to claim 1, wherein the at least one sidewall comprises a peripheral edge forming a fillet at the periphery of bottom of the base.

7. The appliance according to claim 1, wherein the bowl comprises a lower portion shaped so as to cooperate with a stand arranged on the base of the appliance.

8. The appliance according to claim 1, comprising a controller configured to drive at least the weighing device.

9. The appliance according to claim 8, wherein the controller comprises a display member configured to display weight information of the content of the bowl measured by the at least one weighing sensor.

10. The appliance according to claim 1, comprising at least one foot arranged on the support plate irrespective of the position of the weighing sensors.
